(19) United States
(12) Patent Application Publication
(10) Pub. No.: US 2001/0009716 A1
(43) Pub. Date: Jul. 26, 2001

(54) MICROPOROUS STRUCTURES AND PROCESS FOR PRODUCING THE SAME

(76) Inventors: TOHRU TAGUCHI, KANAGAWA (JP); ITARU KUTSUWA, KANAGAWA (JP); KAZUHIKO YAMADA, KANAGAWA (JP); SHINSUKE YAMADA, KANAGAWA (JP); HIROYUKI NISHIMURA, KANAGAWA (JP)

Correspondence Address: SUGHRUE MION ZINN, MACPEAK & SEAS, 2100 PENNSYLVANIA AVENUE NW, WASHINGTON, DC, 20037

(21) Appl. No.: 09/162,504

(22) Filed: Sep. 29, 1998

(30) Foreign Application Priority Data
Sep. 30, 1997 (JP) HEI 9-284503
Jun. 16, 1998 (JP) HEI 10-186858

(51) Int. Cl. C08J 9/38; C08J 9/26

(52) U.S. Cl. 428/315.5; 521/52; 521/64

(57) ABSTRACT

Microporous structures characterized by having a three-dimensional interconnecting network skeleton, which are obtained by comprising mixing a thermoplastic resin, a water-soluble organic compound and a water-soluble polymer material and then eliminating said water-soluble organic compound and said water-soluble polymer material by extracting with water. A process for producing microporous structures comprising mixing a thermoplastic resin with water-soluble components which contain a water-soluble organic compound and a water-soluble polymer material, at a specific volume ratio, thus forming a mixture having a three-dimensional interconnecting network skeleton made of said thermoplastic resin wherein said water-soluble components are maintained, bringing said mixture into contact with water and thus extracting and eliminating said water-soluble components from said mixture, wherein a volume ratio of the water-soluble organic compound to the water-soluble polymer material ranges from 35 to 95/65 to 5.

### FIELD OF THE INVENTION

This invention relates to microporous structures having a three-dimensional network skeleton interconnected with cavities and showing, in particular, an extremely small pore size and a high porosity. The present invention further relates to a process for easily producing the above-mentioned microporous structures showing a small pore size and a high porosity which comprises mixing three specific components and then bringing the resultant mixture into contact with water. The microporous structures of the present invention are widely usable in for example, functional separative membranes such as filter membranes, water stop materials, controlled release materials, water-retention materials and various members capable of absorbing organic solvents and maintaining the same such as ink pads for solvent-type inks.

### BACKGROUND OF THE INVENTION

There has been already known methods for producing porous structures having a three-dimensional interconnecting network skeleton which comprise mixing a high-molecular weight material with a low-molecular weight material, kneading the resulting mixture under heating and then extracting and eliminating the low-molecular weight material with an appropriate solvent. For example, JP-A-58-189242 discloses a process for obtaining high-molecular weight porous structures by molding a polymer composition, which contains a polymer material and a pore-forming agent soluble or swelling in both of a good solvent and a poor solvent compatible with the good solvent, into a mold with a cavity of porous through holes therein, allowing the mixture to gel and demolding and extracting and eliminating the pore-forming agent with the poor solvent or vapor of the same (the term “JP-A” as used herein means an “unexamined published Japanese patent application”).

JP-A-8-176336 discloses a process for obtaining microporous structures having a three-dimensional interconnecting network skeleton by mixing syndiotactic 1,2-polybutadiene with various low-molecular weight materials, then dissolving and extracting the low-molecular weight materials with a solvent such as acetone or alcohol, and eliminating the remaining solvent. Further, JP-A-8-238484 discloses a process for obtaining microporous structures having a three-dimensional interconnecting network skeleton by mixing ethylene/vinyl acetate copolymer with various low-molecular weight materials, stirring the resultant mixture at a high speed, then dissolving and extracting the low-molecular weight materials with a solvent such as xylene, toluene or benzene, and eliminating the remaining solvent.

However, two-component systems are employed in most of these conventional methods and, therefore, it is difficult to extract and eliminate the low-molecular weight materials. To ensure the elimination of the low-molecular weight materials, it is necessary to press the mixtures with a roll, a pressing machine, etc. or to apply a centrifugal force thereto with a centrifuge before the extraction with solvents. When such a physical and forced procedure is employed, it is sometimes impossible to give any homogeneous porous structure with continuously connected channels of cavities. To form a uniform three-dimensional interconnecting network skeleton by these conventional methods, it is needed in some cases to stir the mixture not at a low speed with the use of a conventional rotor-type mixer, etc. but at a high speed with the use of a high-speed stirrer, etc.

As described in the patents cited above, it has been a practice to extract and eliminate the low-molecular weight materials by using organic solvents such as acetone, alcohols and aromatic solvents. Use of these organic solvents is undesirable from the viewpoint of the working environment and, moreover, there arises a disposal problem of these solvents discharged as wastes in a large amount. In the case of a two-component system, the pore size of the porous structure thus obtained depends on the particle size of a low-molecular weight material, because the low-molecular material is often in the form of a solid. Thus, it is very difficult to obtain porous structures having fine and homogeneous pores. In addition, the mixture of a high-molecular weight material with such a low-molecular weight material has an extremely high viscosity and thus no molding method other than press-molding is applicable thereto. When the low-molecular weight material is in the form of a liquid, on the other hand, the pore size of the porous product depends on the compatibility of the high-molecular weight material with the low-molecular weight material. In this case, however, it is generally difficult to form a fine and continuous phase made of the low-molecular weight material. Moreover, this fine and continuous phase is very unstable and thus it is difficult to solidify the high-molecular weight material while maintaining this situation. Anyway, porous structures having an elevated fineness can be hardly obtained by the conventional methods.

### SUMMARY OF THE INVENTION

The present invention aims at solving the above-mentioned problems encountering in the prior art. Namely, an object of the present invention is to provide microporous structures having a three-dimensional interconnecting network skeleton made of a thermoplastic resin, in particular, porous structures having an extremely small pore and good continuously connected channels of cavities. Another object of the present invention is to provide a process for producing homogeneous microporous structures comprising mixing a thermoplastic resin with a water-soluble organic compound such as urea and a water-soluble polymer material such as polyethylene glycol, and then extracting and eliminating the water-soluble organic compound and the water-soluble polymer material with water.

The microporous structures according to the first embodiment, which are characterized by having a three-dimensional interconnecting network skeleton, can be obtained by comprising mixing a thermoplastic resin, a water-soluble organic compound and a water-soluble polymer material and then eliminating the water-soluble organic compound and the water-soluble polymer material by extracting with water.

In the second embodiment, the microporous structures as described in the first embodiment have a pore size of 30 μm or less and a porosity of from 60 to 90%.

The process for producing microporous structures according to the third embodiment comprises mixing a thermoplastic resin with water-soluble components which contain a water-soluble organic compound and a water-soluble polymer material, at a specific volume ratio, thus forming a mixture having a three-dimensional interconnecting network skeleton made of the thermoplastic resin wherein the water-soluble components are maintained, bringing the mixture into contact with water and thus extracting and eliminating the water-soluble components from the mixture, wherein a volume ratio of the water-soluble organic compound to the water-soluble polymer material ranges from 35 to 95/65 to 5.

In the fourth embodiment, the process for producing microporous structures as described in the third embodiment is characterized in that the thermoplastic resin and the water-soluble polymer material are in a molten state while the water-soluble organic compound remains solid at the step of mixing.

In the fifth embodiment, the process for producing microporous structures as described in the third embodiment or the fourth embodiment is characterized in that the melting point of the water-soluble organic compound is higher than the melting point or softening point of the thermoplastic resin and the melting point of the water-soluble polymer material, and the temperature at the step of mixing is lower than the melting point of the water-soluble organic compound but exceeds the melting point or softening point of the thermoplastic resin and the melting point of the water-soluble polymer material.

In the sixth embodiment, the process for producing microporous structures as described in any of the third embodiment to the fifth embodiment is characterized in that the thermoplastic resin is ethylene/vinyl acetate copolymer, ethylene/methyl methacrylate copolymer or syndiotactic 1,2-polybutadiene, the water-soluble organic compound is urea and the water-soluble polymer material is polyethylene glycol.

In the seventh embodiment, the process for producing microporous structures as described in any of the third embodiment to the sixth embodiment is characterized in that the temperature of said water is from 50 to 90° C.

### DETAILED DESCRIPTION OF THE INVENTION

As the above-mentioned “thermoplastic resin”, use can be made of those which can be molten at the step of mixing and thus uniformly dispersed with other components. Examples of the thermoplastic resin include ethylene/vinyl acetate copolymer (hereinafter referred to simply as “EVA”), ethylene/methyl methacrylate copolymer (hereinafter referred to simply as “EMMA”), syndiotactic 1,2-polybutadiene (hereinafter referred to simply as “1,2-PB”), thermoplastic polyurethane, polyolefins such as polyethylene and polypropyelne, polystyrene, polyamide, polyester, polyvinyl chloride and polysulfone. Although one of these thermoplastic resins is employed alone in general, two or more thereof may be used together so long as these resins have melting points or softening points close to each other and show a compatibility of a certain degree.

As the above-mentioned “water-soluble organic compound”, use can be made of crystalline compounds having a melting point and being soluble in cold or warm water. Examples of the water-soluble organic compound include urea, thiourea, dicyanodiamide, saccharides such as mannitol, fructose and glucose, trimethylolethane, pentaerythritol, acrinol, aconitic acid, aconic acid, acetylbenzoic acid, acetylthiourea, acetylenecarboxylic acid, acetamideophenol, atropine sulfate, anisic acid, aniline hydrochloride, aminoacetanilide, aminobenzoic acid, aminovaleric acid, aminocinnamic acid, aminobutyric acid, alanine, arsanilic acid, arbutin, arecaidine, alloxanic acid, sodium benzoate, anthranilic acid, isatin, isatin oxime, isocanphoronic acid, isosaccharic acid, isonicotinic acid, isonicotinic acid hydrazide, isovaleramide, isophthalonitrile, isoproterenol hydrochloride, itaconic acid, sodium glutamate, indazole, uracil, ethylamine hydrobromide, epicathechin, ephedrine hydrochloride, emetine hydrochloride, ergonovine, euxanthic acid, oxanilic acid, oxaloacetic acid, hydroxydiacetic acid, opianic acid, potassium oleate, catechin, caffeine, ammonium carbamate, carbonohydrazide, carminic acid, potassium formate, sodium formate, quinic acid, quinuclidine, quinolinol, quinolone, quinhydrone, guanidine carbonate, glyoxime, glycocyamidine, glycocyamine, glycine, glutaconic acid, crotonic acid, clorobenzoic acid, chlorofumaric acid, chlorpromazine hydrochloride, kojic acid, cocaine hydrochloride, codeine phosphate, succinic acid, zinc acetate, potassium acetate, sodium acetate, lead acetate, salicin, sarcosine, cyanidin chloride, trimethyl cyanurate, dialuric acid, diethylamine hydrochloride, cyclobarbital, cytidine, diphenylacetic acid, dimethylamine hydrochloride, dimethylparabanic acid, dimethylmalonic acid, camphorquinone, dilituric acid, succinamide, succinamic acid, stachydrine, potassium stearate, sodium stearate, sulfadiazine, sulfamethizole, semicarbazide hydrochloride, taurine, tartronic acid, tetraethylammonium iodide, tetrazole, tetronic acid, delphinidin chloride, terpenylic acid, terebic acid, triethylamine hydrochloride, trimethylamine hydrochloride, trimethylamine oxide, tropinic acid, nicotinic acid, nitroguanidine, nitroterephthalic acid, nitrone, ninhydrin, hippuric acid, biuret, violuric acid, hydantoin, hydantoic acid, hydroquinone, pyrazolone, pilocarpine hydrochloride, phenylarsonic acid, phenylsuccinic acid, phenylurea, phenylhydrazine hydrochloride, phenylpropiolic acid, phenylboronic acid, phthalamic acid, phthalonic acid, flavianic acid, purine, fulminuric acid, procaine hydrochloride, promazine hydrochloride, bromosuccinic acid, bromofumaric acid, bromomaleic acid, bromovalerylurea, hexamethylphosphoric triamide, hexamethylene tetraamine, hexobarbital, hesperetic acid, betaine, petidine hydrochloride, hematoxylin, hemin, pelargonidin chloride, benzylidenemalonic acid, benzilic acid, benzenehexacarboxylic acid, benzenepentacarboxylic acid, benzoimidazole, ethyl gallate, mitomycin C, mesaconic acid, methylamine hydrochloride, methylarsonic acid, mercaptosuccinic acid, morphine hydrochloride, iodocyanogen and leuconic acid.

As the above-mentioned “water-soluble polymer material”, use can be made of those which can be easily extracted and eliminated with cold or warm water together with the water-soluble organic compound. Examples of the water-soluble polymer material include polyethylene glycol, polyethylene glycol/polypropylene glycol copolymer, surfactants such as polyoxyethylene alkyl ethers, in particular, nonionic surfactants wherein alcohols are added to polyethylene glycol, polyethylene glycol/polypropylene glycol copolymer, etc., polyaminesulfone, polyvinyl alcohol, polyvinyl methyl ether and polyallylamine.

It is particularly preferable to use, as the water-soluble polymer material, polyethylene glycol which is highly soluble in water and excellent in the effect of promoting the extraction and elimination of the water-soluble organic compound. As this polyethylene glycol, use can be made of those having a weight-average molecular weight of from 1,000 to 30,000. When the mixture is to be press-molded into a definite shape prior to the contact with water, it is preferable to use polyethylene glycol having a weight-average molecular weight of from 1,000 to 10,000, still preferably from 1,000 to 6,000. In the case where extrusion molding is performed, on the other hand, a homogeneously blended intermediate can be obtained even by using polyethylene glycol having a large molecular weight of from 10,000 to 30,000, in particular, from 15,000 to 25,000.

In the third embodiment, it is preferable to regulate the ratio of the thermoplastic resin to the above-mentioned “water-soluble components” depending on the type of the thermoplastic resin. In the case of EVA and 1,2-PB, it is preferable that these thermoplastic resins are employed in an amount of from 8 to 45% by volume while the water-soluble components are employed in an amount of from 55 to 92% by volume. In the case of EMMA, on the other hand, it is preferable that EMMA is employed in an amount of from 15 to 55% by volume while the water-soluble components are employed in an amount of from 45 to 85% by volume. When the thermoplastic resin is employed in an amount less than the lower limit (i.e., the amount of the water-soluble components exceeding the upper limit), no three-dimensional interconnecting network skeleton can be formed and thus any microporous structure cannot be obtained. This is suggested by the fact that when such a mixture is brought into contact with water, the thermoplastic resin is also dissolved and dispersed in water. When the amount of the thermoplastic resin exceeds the upper limit (i.e., the amount of the water-soluble component being less than the lower limit), on the other hand, the resultant mixture is unusable in practice, since it takes a long time to extract and eliminate the water-soluble components. In such a case, moreover, a series of continuously connected channels are deteriorated both theoretically and actually and, therefore, the obtained microporous structure fails to form a homogeneous three-dimensional interconnecting network skeleton.

The volume ratio of the water-soluble organic compound to the water-soluble polymer material ranges from 35 to 95/65 to 5. That is, the amount of the water-soluble organic compound is from 35 to 95% by volume based on the amount of the water-soluble components and the remainder of the water-soluble components is the water-soluble polymer material.

When the volume ratio of the water-soluble organic compound is less than 35 (i.e., the volume ratio of the water-soluble polymer material exceeding 65), no three-dimensional interconnecting network skeleton can be formed. This is suggested by the fact that when such a mixture is brought into contact with water, the thermoplastic resin is also dispersed in water. In such a case, therefore, no microporous structure can be obtained. When the volume ratio of the water-soluble organic compound exceeds 95 (i.e., the volume ratio of the water-soluble polymer material being less than 5), the water-soluble organic compound can be hardly extracted and eliminated. As a result, the continuously connected channels and cavities of the product are both deteriorated and thus it becomes impossible to give any microporous structure having a homogeneous three-dimensional interconnecting network skeleton. In the case of some thermoplastic resins, microporous structures having a small pore size and a high porosity can be easily obtained, even though the volume ratio of the water-soluble organic compound to the water-soluble polymer material ranges from 45 to 90/55 to 10.

It is particularly preferable to regulate the amount of the thermoplastic resin to 15 to 35% by volume. Namely, the ratio of the water-soluble components is preferably controlled to from 65 to 85% by volume based on the whole mixture. Furthermore, it is preferable to regulate the amount of the water-soluble organic compound in the water-soluble components to 45 to 85% by volume. Namely, the amount of the water-soluble polymer material in the water-soluble components preferably ranges from 55 to 15% by volume.

When the volume ratios of the thermoplastic resin, the water-soluble organic compound and the water-soluble organic compound are regulated each within the range as specified above, the water-soluble organic compound and the water-soluble polymer material can be easily and sufficiently extracted and eliminated. As a result, it becomes possible to form a homogeneous three-dimensional interconnecting network skeleton having a sufficient strength made of the thermoplastic resin. Thus, homogeneous microporous structures having a small pore size of “30 μm or less”, as defined in the second embodiment, particularly 10 μm or less and still particularly 5 μm or less, can be obtained. Furthermore, microporous structures having a sufficient strength and a porosity of “from 60 to 90%”, as defined in the second embodiment, particularly from 65 to 85%, can be obtained. The term “pore size” as used herein means a value read from an electronmicroscopic photograph of the section of the porous structure, while the term “porosity” as used herein means a value determined in accordance with the following formula.

$$Porosity ( \% ) = \frac{( apparent density of porous structure )}{( true density of thermoplastic resin )} \times 100$$

wherein the apparent density of the porous structure means a value calculated by dividing the weight of the porous structure molded into a sheet by the volume (i.e., the product of the thickness of the porous structure by the bottom area thereof).

As described above, various materials are usable as the thermoplastic resin, the water-soluble organic compound and the water-soluble polymer material. It is preferable, as stated in the fourth embodiment, to perform the mixing under such conditions that the thermoplastic resin and the water-soluble polymer material are in a molten state while the water-soluble organic compound remains solid. These mixing conditions can be achieved by using a water-soluble organic compound having a melting point higher than those of the thermoplastic resin and the water-soluble polymer material and carrying out the mixing at a temperature between i) the melting point of the water-soluble organic compound and ii) the melting point or softening point of the thermoplastic resin and the melting point of the water-soluble polymer material. By mixing the components under these conditions, the water-soluble organic compound becomes more homogeneous and finer owing to the kneading effect and thus microporous structures having excellent continuous channels of cavities and fine cells can be obtained.

As stated in the fifth embodiment, it is particularly preferable to use, as the water-soluble organic compound, a compound the melting point of which is higher than the melting point or softening point of the thermoplastic resin and the melting point of the water-soluble polymer material. It is still preferable to set the temperature at the mixing step within a range lower than the melting point of the water-soluble organic compound but higher than the melting point, etc. of the thermoplastic resin and the melting point of the water-soluble polymer material. It is preferable that the difference between i) the melting point of the water-soluble organic compound and ii) the melting point, etc. of the thermoplastic resin and the melting point of the water-soluble polymer material is 70° C. or less, still preferably 50° C. or less. When the components are mixed under the conditions as specified above, the kneading effect on the water-soluble organic compound is further elevated and thus the water-soluble organic compound can be converted into uniform and fine particles. That is to say, fine particles having a particle size of 5 to 15 μm, in particular about 10 μm, can be obtained owing to the kneading effect in the mixing step, regardless of the starting particle size of the water-soluble organic compound. As a result, microporous structures having more homogeneous and finer, continuously connected channels of cavities can be obtained.

The sixth embodiment provides an example of the combination of the components satisfying the requirements for the melting point or softening point specified in the fifth embodiment. That is to say, EVA, EMMA or 1,2-PB is used as the thermoplastic resin, while urea and polyethylene glycol are used respectively as the water-soluble organic compound and the water-soluble polymer material. When this combination is used and the mixing temperature is regulated between the melting points, etc. thereof, it is possible to obtain microporous structures being excellent in strength, durability, etc. and having a small pore size, a good homogeneity and a good series of continuously connected channels.

In the present invention, the thermoplastic resin, the water-soluble organic compound and the water-soluble polymer material are mixed by using an apparatus commonly employed in the art, for example, a rotor-type mixer, a kneader, a kneading roll, a Banbury type mixer or a twin-screw extruder. It is completely unnecessary to perform the mixing at a particularly high speed. In the case of a rotor-type mixer, for example, the desired effect can be fully achieved by mixing at from 100 to 300 rpm, in particular from 120 to 200 rpm. In the mixing step, the temperature is regulated to 60 to 150° C., in particular to 80 to 140° C. The temperature may be appropriately adjusted depending on the melting point, etc. of the thermoplastic resin, etc. employed. It is particularly preferable that the mixing temperature is set in such a manner as stated in the above fourth or fifth embodiment. The mixing may be continued for 10 to 40 minutes, in particular for 15 to 30 minutes, though the present invention is not restricted thereto. When the mixing time is excessively short, each component cannot be sufficiently dispersed uniformly and thus it is impossible in some cases to obtain homogeneous microporous structures. However, it is usually enough to stir the components for 40 minutes. An unnecessarily long mixing time might induce the deterioration of the thermoplastic resin, etc.

After mixing these components, the “mixture” thus formed is brought into contact with “water”. The contact may be carried out in an arbitrary manner, so long as the water-soluble components can be sufficiently extracted and eliminated. A preferable example thereof is to immerse the mixture in water. By using this immersion method, the water-soluble components can be easily and surely extracted and eliminated from the three-dimensional interconnecting network skeleton. When the water-soluble components are those which can be easily eluted, the water temperature may be from 20 to 30° C. However, it is preferable to elevate the water temperature so as to perform the extraction and elimination more quickly and surely. As stated in the seventh embodiment, the water temperature preferably ranges “from 50 to 90° C.”, in particular from 60 to 80° C. The immersion time may be optionally regulated within a range of from several minutes to 2 or 3 hours. If necessary, the mixture may be immersed in water at 20 to 30° C. for several ten hours.

To easily and surely extract and eliminate the water-soluble components, it is preferable that the mixture is in the form of not a mass but a sheet or a film. It is therefore preferable to preliminarily mold the mixture into a definite shape determined depending on the purpose, etc. The molding may be carried out by an arbitrary method such as press-molding or extrusion molding. It is particularly preferable to employ the extrusion method therefor, since the mixture can be uniformly heated thereby to give a homogeneous sheet having a high mechanical strength. In particular, EMMA is excellent in the extrusion molding properties and thus a more homogeneous and stronger sheet can be obtained by using the same. When the mixture is molded into a sheet, etc. and then immersed in warm water as described above, the water-soluble components can be sufficiently extracted and eliminated within a short immersion time of 5 to 20 minutes, in particular 5 to 15 minutes. Similarly, the water-soluble components can be sufficiently extracted and eliminated even in water at a relatively low temperature, so long as it is immersed therein for a prolonged period of time.

In the present invention, the water-soluble polymer material is located on the interface of the thermoplastic resin and the water-soluble organic compound at the step of mixing. In particular, when mixing is performed under such conditions as defined in the fourth and fifth embodiments, the highly fluidable water-soluble polymer material accelerates the extraction and elimination of the water-soluble organic compound. Thus, the extraction and elimination can be completed in general merely by bringing the mixture into contact with water. Therefore, it is unnecessary to apply pressure, a centrifugal force, etc. to the mixture before or after the contact with water. Although an appropriate procedure such as pressurizing may be employed, care should be taken in such a case not to interfere the formation of a homogeneous and continuously connected pores.

To further illustrate the present invention in greater detail, the following Examples will be given.

(1) Examination on the volume ratio of EVA to water-soluble components

As the thermoplastic resin, use was made of EVA (EVA460™, manufactured by Mitsui-Du Pont Polychemical K.K., Vicat softening point: 64° C.). This thermoplastic resin was mixed with a mixture comprising, at a volume ratio of 60/40, urea (manufactured by Mitsubishi Chemical Corporation, melting point: 132.7° C.) and polyethylene glycol (PEG20000™, manufactured by Sanyo Chemical Industries, Ltd., melting point: 63° C.) at each volume ratio as specified in Table 1. In practice, the volume of each component was converted into its weight with the use of the density thereof and thus mixing was performed based on the weight ratio (the same will apply in the subsequent Examples).

A rotor-type mixer was used in the mixing step. The whole sample was weighed into 100 g and stirred at 150 rpm for 20 minutes at 125° C. Next, the mixture was taken out from the mixer and molded into a sheet (110×1000×1.5 mm) by using an extrusion molding machine regulated at 125° C. The obtained sheet was then immersed in warm water at 70° C. for 2 hours. After taking out from the warm water, the sheet was dried at 40° C. for 12 hours to give a microporous structure. Table 1 shows the weights of the sheet before and after the immersion and the extraction ratio which was calculated in accordance with the following formula.

$$\begin{matrix}Extraction \\ ratio ( \% )\end{matrix} = \frac{\begin{matrix}sheet weight \\ before immersion\end{matrix} - \begin{matrix}sheet weight \\ after immersion\end{matrix}}{\begin{matrix}weight of water \text{-} soluble organic compound \\ and water \text{-} soluble polymer material \\ contained in sheet before immersion\end{matrix}} \times 100.$$

TABLE 1

| | Ref. | | | | Ref. |
|---|---|---|---|---|---|
| | Exam. | Exam. | Exam. | Exam. | Exam. |
| | 1 | 1 | 2 | 3 | 2 |
| Composition: | | | | | |
| EVA (vol. %) | 5 | 10 | 30 | 40 | 50 |
| urea + PEG (vol. %) | 95 | 90 | 70 | 60 | 50 |
| Weight: | | | | | |
| before immersion (g) | 16.6 | 18.4 | 17.5 | 20.7 | 19.3 |
| after immersion (g) | dissolved | 0.9 | 5.1 | 10.7 | 13.1 |
| Extraction ratio (%) | — | 100 | 93.7 | 72.4 | 56.2 |

Note:
Ref. Exam.: Reference Example
Exam.: Example

As the data given in Table 1 show, the sheet of Reference Example 1 containing EVA in an excessively small amount was completely dissolved, including EVA, when immersed in warm water and thus no porous structure could be obtained. In Examples 1, 2 and 3 wherein the volume ratios of EVA fell within the preferable range, the extraction ratios exceeded 70% and microporous structures with good continuous channels of cavities were obtained. In Example 1 with a less volume ratio of EVA, however, the porous structure had a somewhat insufficient strength due to its thin skeleton. In Example 3 with a high volume ratio of EVA, in contrast, porous structure with sufficient continuous channels of cavities was obtained, though the extraction ratio was somewhat lowered. In Reference Example 2 with an excessively large volume ratio of EVA, the extraction ratio was less than 60% and a large amount of urea, etc. remained among the skeleton of the porous product. In this case, therefore, no porous structure with good continuous channels of cavities could be obtained.

When the thermoplastic resin is never dissolved in warm water while the water-soluble organic compound and the water-soluble polymer material are completely dissolved therein, then the extraction ratio attains 100%. In practice, however, some portion of the thermoplastic resin would migrate into the warm water with a decrease in the volume ratio of the thermoplastic resin. As a result, the calculated extraction ratio might exceed 100% in some cases. With an increase in the volume ratio of the thermoplastic resin, the water-soluble components are incorporated into the skeleton of the porous structure which is under formation. Thus, the water-soluble components remain in the skeleton and closed cells are formed, which causes a decrease in the extraction ratio. When the volume ratio of the thermoplastic resin falls within the preferable range, an extraction ratio of about 70 to 100% can be achieved, as Table 1 shows. Thus, porous structures having a porosity of from 60 to 90% according to the second embodiment can be obtained.

(2) Examination on the volume ratio of water-soluble organic compound to water-soluble polymer material

As the thermoplastic resin, use was made of 20% by volume of EVA similar to the above (1). Then, EVA was mixed with 80% by volume of a mixture of urea and polyethylene glycol similar to the above (1). The volume ratio of urea to polyethylene glycol in this mixture was adjusted as specified in Table 2. Then, the components were mixed, extrusion-molded, immersed in water and dried each in the same manner as the one described in the above (1) to thereby give microporous structures in the form of a sheet of the same size. Table 2 shows the weights of the sheets before and after the immersion and the extraction ratios thereof which were determined in the same manner as the one of (1).

TABLE 2

| | Ref. | Ref. | Ref. | | | | | Ref. |
|---|---|---|---|---|---|---|---|---|
| | Exam. | Exam. | Exam. | Exam. | Exam. | Exam. | Exam. | Exam. |
| | 3 | 4 | 5 | 4 | 5 | 6 | 7 | 6 |
| Composition: | | | | | | | | |
| urea (vol. %) | 7.7 | 9.1 | 30 | 40 | 50 | 60 | 90 | 100 |
| PEG (vol. %) | 92.3 | 90.9 | 70 | 60 | 50 | 40 | 10 | 0 |
| Weight: | | | | | | | | |
| before immersion (g) | 16.0 | 16.6 | 17.5 | 18.0 | 18.8 | 21.5 | 25.1 | 28.6 |
| after immersion (g) | dissolved | do. | do. | 3.5 | 3.2 | 3.4 | 4.0 | 14.9 |
| Extraction ratio (%) | — | — | — | 96.0 | 98.7 | 99.9 | 99.1 | 56.4 |

Note:
Ref. Exam.: Reference Example
Exam.: Example

As the data given in Table 2 show, the sheets of Reference Examples 3 to 5 each containing urea in an amount less than the lower limit as specified in the third embodiment were completely dissolved, including EVA, when immersed in warm water and thus no porous structure could be obtained. In Examples 4 to 7 wherein the volume ratios of urea fell within the range as specified in the third embodiment, the extraction ratios exceeded 95% and microporous structures with good continuous channels of cavities were obtained. In Reference Example 6 wherein the volume ratio of urea exceeded the upper level as specified in the third embodiment, the extraction ratio was less than 60% and a large amount of urea remained among the skeleton of the porous product. In this case, therefore, no porous structure with good continuous channels of cavities could be obtained.

(3) Examination on the volume ratio of EMMA to water-soluble components

As the thermoplastic resin, use was made of EMMA (Acrift WH202™, manufactured by Sumitomo Chemical Co., Ltd., melting point: 86° C.). This thermoplastic resin was mixed with a mixture comprising, at a volume ratio of 60/40, urea and polyethylene glycol at each volume ratio as specified in Table 3. The urea and polyethylene glycol employed herein were the same as those described in the above (1).

A Laboplast-Mill (Model 50C150, manufactured by Toyo Seiki Co., Ltd.) was used in the mixing step. The whole sample was weighed into 100 g and stirred at 150 rpm for 20 minutes at 125° C. Next, the mixture was taken out from the mill and molded into a sheet (120 mm in width, 1.2 mm in thickness) by using a Laboplast-Mill twin-screw extrusion molding machine at 50 rpm at a die temperature of 110° C. Next, a test piece (100×100×1.2 mm) was cut off from this sheet and immersed in water at 20° C. for 48 hours. After taking out from the water, the sheet was dried at 30 ° C. for 12 hours to give a microporous structure. Table 3 shows the extraction ratios determined in the same manner as the one of the above (1).

TABLE 3

| | Reference | Exam- | Exam- | Exam- | |
|---|---|---|---|---|---|
| | Example | ple | ple | ple | Example |
| Composition: | 7 | 8 | 9 | 10 | 11 |
| EMMA (vol. %) | 10 | 20 | 30 | 40 | 50 |
| urea/PEG (vol. %) | 36/54 | 32/48 | 28/42 | 24/36 | 20/30 |
| Extraction ratio (%) | dis- | 95.1 | 98.4 | 100 | 97.9 |
| | solved | | | | |
| | can't | | | | |
| | measured | | | | |

As the data given in Table 3 show, the sheet of Reference Example 7 containing EMMA in an excessively small amount was completely dissolved, including EMMA, when immersed in warm water and thus no porous structure could be obtained. In Examples 8 to 11 wherein the volume ratios of EMMA fell within the preferable range, the extraction ratios exceeded 95% and microporous structures with good continuous channels of cavities were obtained. In Example 8 with a relatively less volume ratio of EMMA, however, the porous structure had a somewhat insufficient strength due to its thin skeleton.

(4) Evaluation of various thermoplastic resins

As the thermoplastic resin, use was made of 1,2-PB (RB810™, manufactured by JSR K.K., melting point: 71° C.). Similar to the above (1), urea and polyethylene glycol were used respectively as the water-soluble organic compound and the water-soluble polymer material. 20% by volume of 1,2-PB was mixed with 80% by volume of a mixture of urea with polyethylene glycol. The volume ratio of urea to polyethylene glycol was 60/40.

Then, extrusion molding, immersion in water and drying were performed each in the same manner as the one described in (1) to give a microporous structure in the form of a sheet of the same size but adjusting the mixing temperature to 110° C. This sheet showed an extraction ratio of 80%. The microporous structure thus obtained showed a pore size of 10 μm and a porosity of 75%. It exhibited a sufficient strength. Microscopic observation of the section of this microporous structure indicated that it was a homogeneous porous structure having good continuous channels of cavities.

The above procedure was repeated but using 25% by volume of 1,2-PB and 75% by volume of a mixture of urea with polyethylene glycol to thereby give another microporous structure in the form of a sheet. This sheet showed an extraction ratio of 100%. The microporous structure thus obtained showed a pore size of 10 μm and a porosity of 80%. It exhibited a sufficient strength. Microscopic observation of the section of this microporous structure indicated that it was a homogeneous porous structure having good continuous channels of cavities.

As the thermoplastic resin, use was made of the various ones as will be specified below. Then, stirring, mixing, extrusion molding, immersion in water and drying were performed each in the same manner as the one described in (1) but using these thermoplastic resins and 80% by volume or 75% by volume of the same mixture of urea with polyethylene glycol as above to give microporous structures in the form of a sheet of the same size. The volume ratio of urea to polyethylene glycol was 60/40 in each case:

a) 1,2-PB (RB820™, manufactured by JSR K.K., melting point: 95° C.);

b) 1,2-PB (RB830™, manufactured by JSR K.K., melting point: 105° C.);

c) EVA (EVA260™, manufactured by Mitsui-Du Pont Polychemical K.K., melting point 41° C.);

d) EVA (EVA460™, manufactured by Mitsui-Du Pont Polychemical K.K., Vicat softening point: 64° C.);

e) EVA (EVA560™, manufactured by Mitsui-Du Pont Polychemical K.K., Vicat softening point: 66° C.); and

f) thermoplastic polyurethane (P22M™, manufactured by Nippon Mirakuton K.K., melting point: 64° C.).

Each of the porous structures thus obtained exhibited a sufficient strength. Microscopic observation of the section of this microporous structure indicated that it was a homogeneous porous structure having good continuous channels of cavities.

(5) Comparative evaluation of EVA, 1,2-PB and EMMA in solvent resistance

Test pieces (30×30 mm) were cut off from the sheet with the use of EVA in (1), the sheet with the use of EMMA in (3) and the sheet with the use of 1,2-PB (RB810™ manufactured by JSR K.K.) in (4). Then these test pieces were immersed in the organic solvents as listed in Table 4 and the expansivity (%) in each case was calculated in accordance with the following formula to thereby evaluate the solvent resistance. The sheets employed as the test pieces contained the thermoplastic resin and the water-soluble components at a volume ratio of 40:60 ((1) and (3)) or 20:80 ((4)). The volume ratio of urea to polyethylene glycol was 40:60 in every case. Table 4 summarizes the results wherein “O” means “neither dissolved nor swollen”, “Δ” means “somewhat swollen” and “x” means “dissolved”.

$$Expansivity ( \% ) = \frac{\begin{matrix}volume after \\ immersion\end{matrix} - \begin{matrix}volume before \\ immersion\end{matrix}}{volume after immersion} \times 100.$$

TABLE 4

| | EVA | | 1,2-PB | | EMMA | |
|---|---|---|---|---|---|---|
| | | Solvent | | Solvent | | Solvent |
| Solvent | Expansivity | resistance | Expansivity | resistance | Expansivity | resistance |
| acetone | no change | ∘ | no change | ∘ | 2.18 | Δ |
| methanol | no change | ∘ | no change | ∘ | 0.82 | ∘ |
| ethanol | 3.82 | Δ | 0.16 | ∘ | 0.14 | ∘ |
| isopropanol | 4.80 | Δ | 1.26 | ∘ | no change | ∘ |
| hexane | 25.53 | Δ | 13.70 | Δ | 10.29 | Δ |
| heptane | 20.39 | Δ | 44.60 | Δ | 0.07 | ∘ |
| benzene | 40.70 | Δ | dissolved | x | 3.60 | Δ |
| toluene | 58.59 | Δ | dissolved | x | 5.27 | Δ |
| methylcyclohexane | 45.66 | Δ | dissolved | x | 18.57 | Δ |
| 2-ethoxyethanol | 1.33 | ∘ | 1.00 | ∘ | 1.44 | ∘ |
| trichloroethylene | 12.19 | Δ | dissolved | x | 16.17 | Δ |
| 2-nitropropane | no change | ∘ | 2.11 | Δ | 2.83 | Δ |

The data given in Table 4 show that when a sheet was produced by using EMMA as a thermoplastic resin not by compression molding but by extrusion molding, a low expansivity and a high solvent resistance were achieved, compared with the sheets produced by using EVA or 1,2-PB. Namely, microporous structures containing EMMA sustain the excellent solvent resistance inherent to EMMA. Accordingly, when products from which inks sustained therein ooze out, such as an ink pad, etc. are made of these microporous structures, solvent-type inks which cannot be employed in such products in the prior art are applicable thereto.

(6) Evaluation of water-soluble organic compounds other than urea

As the thermoplastic resin, use was made of thermoplastic polyurethane (P22M™, manufactured by Nippon Mirakuton K.K., melting point: 64° C.) while pentaerythritol (melting point>180° C.) was employed as the water-soluble organic compound. As the water-soluble polymer material, use was made of the same polyethylene glycol as the one employed in the above (1). The volume ratio of pentaerythritol to polyethylene glycol was 60/40.

Then, extrusion molding, immersion in water and drying were performed each in the same manner as the one described in (1) but adjusting the mixing temperature to 160° C. Thus, a practically usable microporous structure showing an extraction ratio of 81.0%, a pore size of 5 to 30 μm and a porosity of 55 to 60% could be obtained, though it took a longer time to extract and eliminate the water-soluble components, compared with the case wherein urea was employed.

Further, a microporous structure was produced by the same methods as the one described above but using mannitol (melting point: 165° C.) as a substitute for pentaerythritol and adjusting the mixing temperature to 140° C. Thus, a practically usable microporous structure showing an extraction ratio of 84.8%, a pore size of 5 to 30 μm and a porosity of 55 to 60% could be obtained, though it took a longer time to extract and eliminate the water-soluble components, compared with the case wherein urea was employed similar to the case of pentaerythritol.

According to the first embodiment, a microporous structure having a three-dimensional interconnecting network skeleton can be obtained. As stated in the second embodiment, in particular, a small pore size and a high porosity can be imparted to this microporous structure. According to the third embodiment, the microporous structures of the first and second embodiments can be easily produced. In particular, this process is free from any troubles, e.g., harmful effects on the environment and disposal of wastes, since no organic solvent is employed in the step of the extraction and elimination of water-soluble organic compounds. By specifying the melting point of each component and the mixing temperature as done in the fourth and fifth embodiments, moreover, a microporous structure having improved uniformity and a series of continuous channels of cavities can be produced.

While the invention has been described in detail and with reference to specific embodiments thereof, it will be apparent to one skilled in the art that various changes and modifications can be made therein without departing from the spirit and scope thereof.

What is claimed is:

1. Microporous structures characterized by having a three-dimensional interconnecting network skeleton, which are obtained by comprising mixing a thermoplastic resin, a water-soluble organic compound and a water-soluble polymer material and then eliminating said water-soluble organic compound and said water-soluble polymer material by extracting with water.

2. The microporous structures as claimed in claim 1 which have a pore size of 30 μm or less and a porosity of from 60 to 90%.

3. A process for producing microporous structures comprising mixing a thermoplastic resin with water-soluble components which contain a water-soluble organic compound and a water-soluble polymer material, at a specific volume ratio, thus forming a mixture having a three-dimensional interconnecting network skeleton made of said thermoplastic resin wherein said water-soluble components are maintained, bringing said mixture into contact with water and thus extracting and eliminating said water-soluble components from said mixture, wherein a volume ratio of the water-soluble organic compound to the water-soluble polymer material ranges from 35 to 95/65 to 5.

4. The process for producing microporous structures as claimed in claim 3, wherein said thermoplastic resin and said water-soluble polymer material are in a molten state while said water-soluble organic compound remains solid at the step of mixing.

5. The process for producing microporous structures as claimed in claim 3, wherein the melting point of said water-soluble organic compound is higher than the melting point or softening point of said thermoplastic resin and the melting point of said water-soluble polymer material, and the temperature at the step of mixing is lower than the melting point of said water-soluble organic compound but exceeds the melting point or softening point of said thermoplastic resin and the melting point of said water-soluble polymer material.

6. The process for producing microporous structures as claimed in claim 3, wherein said thermoplastic resin is ethylene/vinyl acetate copolymer, ethylene/methyl methacrylate copolymer or syndiotactic 1,2-polybutadiene, said water-soluble organic compound is urea and said water-soluble polymer material is polyethylene glycol.

7. The process for producing microporous structures as claimed in claim 3, wherein the temperature of said water is from 50 to 90° C.
